(19) United States
(12) Patent Application Publication
(10) Pub. No.: US 2005/0200119 A1
(43) Pub. Date: Sep. 15, 2005

(54) Multipurpose label sheet form

(76) Inventor: Vincent Ramirez, Virginia Beach, VA (US)

Correspondence Address: BRADLEY D. GOLDIZEN, 505 SOUTH INDEPENDENCE BOULEVARD, SUITE 102, VIRGINIA BEACH, VA, 23452, US

(21) Appl. No.: 11/077,770

(22) Filed: Mar. 12, 2005

Related U.S. Application Data
(60) Provisional application No. 60/552,580, filed on Mar. 13, 2004.

(51) Int. Cl. B42D 15/00

(52) U.S. Cl. 283/81

(57) ABSTRACT

In the present invention, a form includes a plurality of popular sized labels for printing indicia thereon. Each label includes a perforation for separating the label to create smaller sized labels. The labels include a pressure sensitive adhesive for attaching them to files, shipping packages, business operations and the like. Each label may comprise environmentally friendly material that may be recycled. The adhesive also breaks down during the pulping process for creating recycled paper.

The present application relates to U.S. Provisional Patent Application Ser. No. 60/552,580 filed on Mar. 13, 2004 and claims priority therefrom.

This application did not receive federal research and development funds.

### FIELD OF THE INVENTION

The invention generally relates to multi-use label sheet forms. Removable labels adhere to a backing sheet and include a re-pulp able adhesive. Re-pulp able means that the label may be recycled since the adhesive is broken down during a recycling process to either separate the adhesive from the label or cause the adhesive to break down so as to not adversely affect the recycling process. Each label includes a micro-thin perforation that may be torn to separate the label into two smaller labels. Thus, the labels may be used for larger shipping or mailing labels or separated to be used as small shipping labels or file jacket labels. The labels on the sheet forms are provided in the most popular sizes. For example, the labels may be provided in 3.5 inch wide by either 1 or 2 inches in height. It is therefore unnecessary to provide various sized labels for different business applications.

### BACKGROUND OF THE INVENTION

Previously, various types of labels have been used for different purposes such as mailing or shipping labels, file jacket labels and the like. Each of these labels is different in size and is typically provided on separate backing sheets. The various sheets of labels must be loaded into a printer and the print settings must be changed each time for different uses. Since a mailing or shipping label is somewhat larger than a file jacket label, a user must select the desired size in order to properly print indicia on each label. Until now, a user must load a sheet of labels of the desired size into a printer before use. Thereafter, the user must load a sheet having a different sized label into the printer when a different need for a label arises. Removing and loading the various sized labels leads to a fair amount of increased costs associated with lost productivity.

There is a need for an improved multiple use function label for use in business operations such as inventory control, package shipping, file labeling, and the like. The label must be inexpensive to produce, convenient and simple to use and versatile for use in a variety of business environments and applications.

### BRIEF SUMMARY OF THE INVENTION

The needs mentioned above are satisfied by the label sheet of the present invention that includes at least two different sized labels that may be separated to create smaller sized labels. Multi-use labels on each sheet are provided with a micro-thin perforation that holds each label together until the label is folded and separated into two smaller labels. Thus, each sheet includes four of the most popular sized labels for use in business applications.

Each label comprises face stock that includes a side for printing information thereon and an opposite side coated with a pressure sensitive adhesive. The adhesive comprises a material that breaks down in the pulp-creating step of manufacturing recycled paper such that the materials that comprise the labels may be recycled. The face stock and the backing may also comprise material that is recyclable.

A novel software program is used to print indicia on each label with cross-hair accuracy while accounting for individual printer footprints to provide accurate placement of information on the labels. The indicia may be printed in an upside down fashion such that the perforated edge may be oriented in a desired direction. Likewise, indicial may be printed in a reverse manner. The program uses a special printer line up function that sets the printer such that a printing location is matched with a calibration sheet that may be included with each package of label forms.

It is an object of the invention to provide a multi-ply single sheet label form that includes various sized labels. Each label includes a perforation such that the label may be separated into smaller sized labels.

It is a further object of the invention to provide a single sheet label form that can be utilized for a plurality of business related applications.

It is another object of the invention to provide an environmentally friendly label form that may include recycled material or material that may be recycled after use. The applicant is unaware of the existence of any other environmentally friendly labels for consumer use.

These and other objects and advantages of the invention will be set forth, appear in part or become apparent after considering the specification and accompanying drawings. It is to be realized that the following embodiments of the invention have been represented in their simplest form for ease in understanding the invention.

### BRIEF DESCRIPTION OF THE DRAWINGS

FIG. 1 is a top plan view of the label form.

FIG. 2A is a top plan view of a large file jacket or standard shipping label. Each label comprises two smaller labels connected together.

FIG. 2B is a top plan view of the labels of FIG. 2A shown separated into the smaller labels.

FIG. 3A is a top plan view of a large shipping label that comprises two smaller standard shipping labels.

FIG. 3B is a top plan view of the large shipping label of FIG. 3A separated to create two smaller standard shipping labels.

FIG. 4 is a top plan view of a sheet of large labels.

### DETAILED DESCRIPTION OF THE INVENTION

Although the present invention is herein described in terms of specific embodiments, it will be readily apparent to those skilled in this art that various modifications, rearrangements, and substitutions can be made without departing from the spirit of the invention. The scope of the present invention is thus only limited by the claims appended hereto.

The label forms of the present invention can be utilized in a number of different business operations including materials handling, inventory control and the like. It is to be understood that while the preferred embodiment discloses certain sized labels, it is readily recognizable that other popular sized labels may be substituted for ones disclosed in the preferred embodiment. For purposes of this discussion, the small shipping labels and large file labels are used interchangeably.

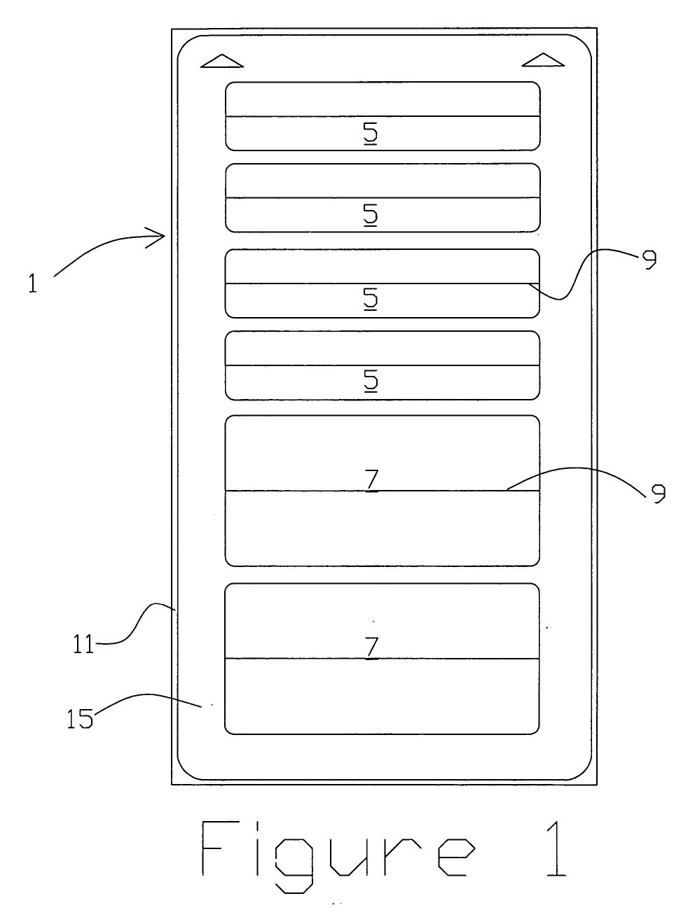

In the preferred embodiment, the label form 1 comprises four 3.5″ wide by 1″ tall small shipping labels 5 as shown in FIG. 1. Two 3.5″ wide by 2″ tall large shipping labels 7 are also provided on the label form 1. Each label comprises face stock 3 that may comprise recyclable or recycled paper. However, different sized labels may be used. A face stock 15 from which the labels are produced is provided on the backing sheet 11. Pressure activated adhesive (not shown) is provided on a side of each label and in contact with a backing sheet 11. The labels 5 and 7 are easily removable from the backing sheet 11 and placed on a desired object such as a package to be shipped or a file jacket. As can be readily recognized, each label form may include 8 large file jacket labels or 8 small file jacket labels and 4 standard mailing labels or 2 large shipping labels or any variation thereof.

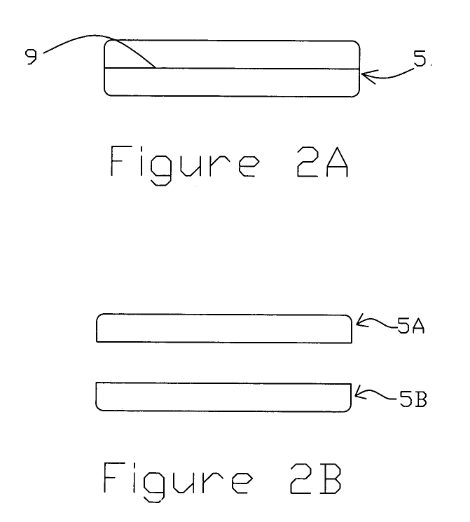

FIGS. 2A and 2B depict use of the small shipping label 5. The shipping label 5 may be used by printing indicia thereon. Alternatively, the shipping label 5 may be separated by folding the label 5 and tearing it at perforation 9 to create two smaller file labels 5A and 5B.

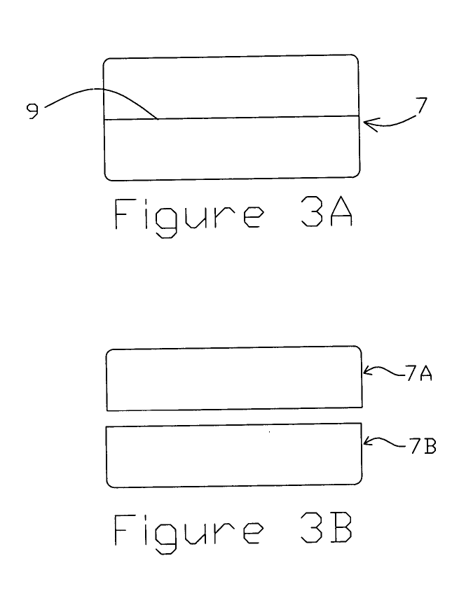

FIGS. 3A and 3B illustrate use of the larger shipping label 7. In FIG. 3A, the shipping label 7 may be used a single label. On the other hand, the shipping label 7 may be separated into two small shipping labels 7A and 7B as shown in FIG. 3B. Shipping label 7 may be separated by folding and tearing label 7 along perforation 9 as mentioned previously.

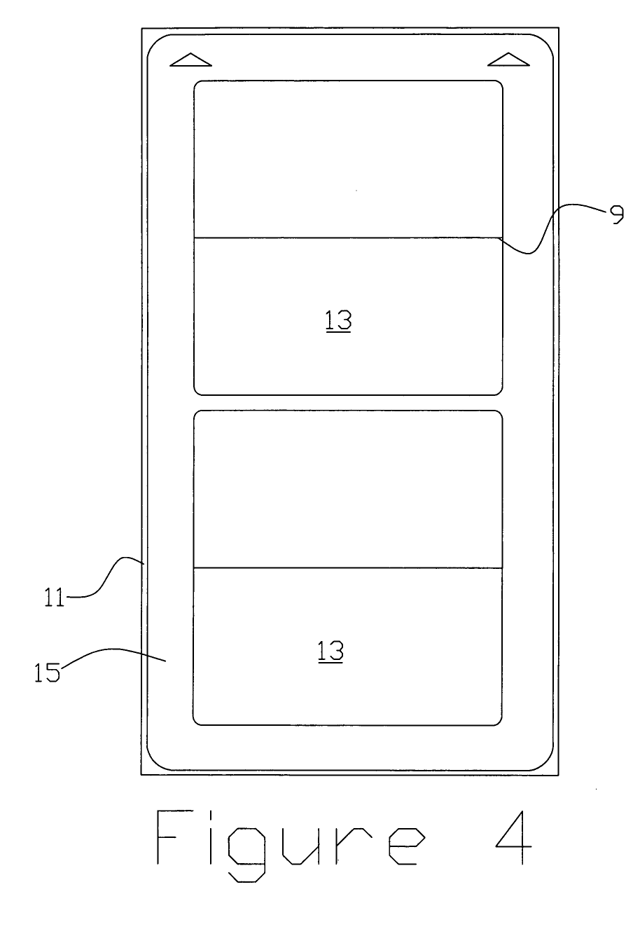

FIG. 4 illustrates the label with larger labels 13, the software program may print the indicial upside down to allow the straight edge created by the perforation to be oriented in a desired manner. Each of the larger labels 13 may be separated to create smaller labels 7. It should be noted that different sized labels may be provided on each form.

While the invention has been described with respect to preferred embodiments, it is intended that all matter contained in the above description or shown in the accompanying drawings shall be interpreted as illustrative and not in limiting sense. From the above disclosure of the general principles of the present invention and the preceding detailed description, those skilled in the art will readily comprehend the various modifications to which the present invention is susceptible. Therefore, the scope of the invention should be limited only by the following claims and equivalents thereof.

1. A multi-use label sheet comprising:
a backing sheet;
a face stock; and,
a plurality of removable labels defined within the face stock, each label comprising a micro-thin perforation that may be torn to separate each label into two smaller labels of equal size, said plurality of removable labels each comprising adhesive for adhering the labels to the backing sheet.

2. The multi-use label sheet of claim 1 wherein said plurality of removable labels comprises at least one 3.5 inch by 1 inch sized label that comprises a micro-thin perforation such that the label may be separated into two 3.5 inch by ½ inch labels.

3. The multi-use label sheet of claim 1 wherein said plurality of removable labels comprises at least one 3.5 inch by 2 inch sized label that comprises a micro-thin perforation such that the label may be separated into two 3.5 inch by 1 inch labels.

4. The multi-use label sheet of claim 1 wherein said plurality of removable labels comprises at least one 3.5 inch by 4 inch sized label that comprises a micro-thin perforation such that the label may be separated into two 3.5 inch by 2 inch labels.

5. The multi-use label sheet of claim 1 wherein said plurality of removable labels further comprises a re-pulp able adhesive.

6. The multi-use label sheet of claim 1 wherein each label comprises face stock that includes a side for printing information thereon and an opposite side coated with a pressure sensitive adhesive.

7. The multi-use label sheet of claim 1 wherein the adhesive comprises a material that breaks down in the pulp-creating step of manufacturing recycled paper such that the labels may be recycled.

8. A label sheet comprising:
a backing sheet; and,
a face stock that comprises a plurality of different sized removable labels defined within the face stock, each label comprising a micro-thin perforation that may be torn to separate each label into two smaller labels of equal size, said plurality of removable labels each comprising adhesive for adhering the labels to the backing sheet.

9. The multi-use label sheet of claim 8 wherein said plurality of removable labels comprises at least one 3.5 inch by 1 inch sized label.

10. The multi-use label sheet of claim 8 wherein said plurality of removable labels comprises at least one 3.5 inch by 2 inch sized label.

11. The multi-use label sheet of claim 8 wherein said plurality of removable labels further comprises a re-pulp able adhesive.

12. The multi-use label sheet of claim 8 wherein each label comprises face stock that includes a side for printing information thereon and an opposite side coated with a pressure sensitive adhesive.

13. The multi-use label sheet of claim 8 wherein the adhesive comprises a material that breaks down in the pulp-creating step of manufacturing recycled paper such that the labels may be recycled.

14. A label sheet comprising:
a backing sheet; and,
face stock that comprises a plurality of different sized removable labels defined within the face stock, each label comprising a micro-thin perforation that may be torn to separate each label into two smaller labels of equal size, said plurality of removable labels each comprising adhesive for adhering the labels to the backing sheet, wherein said at least one of said labels is 3.5 inches wide and 1 inch in height and another of said labels is 3.5 inches wide and 2 inches in height.

15. The multi-use label sheet of claim 14 wherein said plurality of removable labels further comprises a re-pulp able adhesive.

16. The multi-use label sheet of claim 14 wherein each label comprises face stock that includes a side for printing information thereon and an opposite side coated with a pressure sensitive adhesive.

17. The multi-use label sheet of claim 14 wherein the adhesive comprises a material that breaks down in the pulp-creating step of manufacturing recycled paper such that the labels may be recycled.
